(19) United States
(12) Patent Application Publication
(10) Pub. No.: US 2026/0319770 A1
(43) Pub. Date: Oct. 15, 2026

(54) SYSTEM AND METHOD FOR VERIFICATION-PRESERVING COMPILATION USING FORMAL CERTIFICATE GUIDED OPTIMIZATION

(71) Applicant: Houston Hawkins Haynes, Asheville, NC (US)

(72) Inventor: Houston Hawkins Haynes, Asheville, NC (US)

(21) Appl. No.: 19/631,835

(22) Filed: Mar. 27, 2026

Related U.S. Application Data
(60) Provisional application No. 63/786,264, filed on Apr. 9, 2025.

(51) Int. Cl. G06F 8/41

(52) U.S. Cl. CPC G06F 8/41

(57) ABSTRACT

A system and method for verification-preserving compilation in which formal verification certificates are translated into compiler-internal constraint representations that actively guide optimization transformations throughout a multi-stage compilation pipeline. The system comprises a Certificate-Guided Optimization Control System that translates verification certificates from proof systems into MLIR constraint attributes and employs a Transformation Guardian to evaluate each proposed optimization against attached constraints; a Dual-Plane Verification Architecture that separates verification processing from optimization processing while maintaining coordination through a formal protocol; and a Proof Certificate Translation and Preservation mechanism that extracts, normalizes, and progressively lowers verification evidence through all compilation stages, embedding cryptographic digests in the final executable. The compilation system uses a witness architecture in which category-selective observers traverse a program semantic graph and emit structured intermediate representation operations encoding verification properties. Pre-computed immutable coeffect properties including escape analysis, mutability classification, and platform binding resolution constrain all downstream compilation decisions. The system supports multiple compilation targets including CPU, FPGA, NPU, and MCU platforms with target-gated witness registration and target-specific constraint translation. Applications include safety-critical systems, formally verified software deployment, hardware-software co-design, and any domain requiring simultaneous optimization performance and mathematical correctness guarantees.

### CROSS-REFERENCE TO RELATED APPLICATIONS

This Nonprovisional Patent Application claims the benefit of U.S. Provisional Patent Application No. 63/786,264, filed on Apr. 9, 2025, and is directed to the subject matter disclosed therein, the contents of which are hereby incorporated by reference.

### FIELD OF THE INVENTION

The present invention relates to compiler systems that preserve formal verification properties through optimization and code generation stages. More particularly, the invention pertains to a compilation pipeline architecture wherein verification certificates derived from formal proof systems are translated into compiler-internal constraint representations that actively guide optimization transformations, enabling simultaneous achievement of high performance and mathematical correctness guarantees in compiled artifacts.

### BACKGROUND OF THE INVENTION

### The Verification-Performance Tradeoff

Formal verification provides mathematical guarantees about program behavior, including type safety, memory safety, functional correctness, and domain-specific invariants such as dimensional consistency and algebraic structure preservation. These guarantees are established through proof systems that generate certificates attesting to the validity of verified properties. However, the compilation process that transforms verified source programs into executable machine code has historically been unable to maintain these guarantees through optimization stages. This creates a fundamental tension between verification and performance.

### Verified Compilers

Verified compilers such as CompCert address correctness by proving the compiler itself preserves semantics. CompCert provides a machine-checked proof in Coq that every transformation in the compilation pipeline preserves the observable behavior of the source program. While this approach guarantees semantic preservation, it restricts the set of applicable optimizations to those that can be formally verified within the proof assistant framework. As a result, CompCert generates code that is typically 10-20% slower than code produced by aggressively optimizing compilers such as GCC or LLVM at their highest optimization levels. The verified compiler approach conflates two distinct concerns: proving the compiler correct and preserving specific program-level verification properties.

### Proof-Carrying Code

Proof-carrying code (PCC) attaches verification evidence to compiled artifacts, enabling consumers to independently verify properties of received code. PCC approaches generate proofs at the source level and translate them alongside the code through compilation. However, existing PCC systems treat proof certificates as passive metadata that accompanies code through transformations. The certificates do not actively influence the optimization process. If an optimization would invalidate a carried proof, the system detects this only after the optimization has been attempted, requiring rollback or recompilation. The proof certificates serve a verification role but not a guidance role.

### Traditional Optimizing Compilers

Modern optimizing compilers such as LLVM and GCC apply aggressive transformation passes including dead code elimination, loop unrolling, constant propagation, function inlining, and vectorization. These compilers operate on intermediate representations that discard verification information early in the pipeline. Type information from the source language is lowered to machine-level representations, formal invariants are not represented in the IR, and domain-specific properties such as dimensional annotations or algebraic grade constraints are entirely absent from the compilation graph. Once verification information is discarded, it cannot be recovered, and the resulting executable provides no assurance that source-level properties hold in the generated code.

### Multi-Level Intermediate Representation

The MLIR (Multi-Level Intermediate Representation) framework, developed as part of the LLVM project, introduces a dialect-based extensible IR that supports multiple abstraction levels within a single compilation graph. MLIR dialects define custom operations, types, and attributes that can represent domain-specific semantics alongside general-purpose computation. However, no existing MLIR-based compiler system uses custom dialects to encode formal verification certificates as first-class compiler entities that guide optimization decisions. The extensibility of MLIR creates an opportunity for a verification-aware compilation system that was not previously realizable within fixed IR designs.

### Nanopass Compilation

The nanopass compilation methodology, originating from Scheme compiler research, decomposes the compilation pipeline into many small, composable transformation passes. Each nanopass performs a single well-defined transformation on the intermediate representation. This architecture provides modularity and inspectability but does not inherently address verification preservation. Existing nanopass systems do not incorporate verification certificates into the pass structure or use formal constraints to govern pass applicability. The nanopass architecture does, however, provide a natural framework for inserting verification-aware decision points at each transformation stage.

### SUMMARY OF THE INVENTION

The present invention provides a system and method for verification-preserving compilation that translates formal verification certificates into compiler-internal constraint representations, uses those constraints to actively guide optimization transformations, and preserves verification evidence through all stages of code generation, from source language through multi-level intermediate representation to machine code. The system resolves the verification-performance tradeoff by enabling aggressive optimization within formally proven constraint boundaries.

The invention comprises three integrated components operating within a multi-stage compilation pipeline. First, a Certificate-Guided Optimization Control System translates verification certificates from formal proof systems into MLIR constraint representations attached to compiler operations, and employs a Transformation Guardian that analyzes all proposed optimizations against these constraints before permitting execution. Second, a Dual-Plane Verification Architecture separates verification processing from optimization processing into coordinated parallel planes, enabling optimization to proceed at full speed within boundaries established by the verification plane. Third, a Proof Certificate Translation and Preservation mechanism extracts, normalizes, and translates formal certificates from source-level proof systems into compiler-internal representations, preserving them through progressive lowering phases and embedding cryptographic verification digests in the final executable.

The system extends the MLIR compiler infrastructure with three novel components: a Certificate Dialect defining custom operations and types for representing verification constraints within the compilation graph; a Verification Pass Manager that coordinates verification-aware optimization passes and enforces constraint satisfaction at each transformation stage; and a Formal Verification Integration layer that bridges external proof systems with the compiler's internal constraint representation.

### BRIEF DESCRIPTION OF THE DRAWINGS

FIG. 1 is a system architecture block diagram showing the overall compilation pipeline with Certificate-Guided Optimization Control, Dual-Plane Verification Architecture, and Proof Certificate Preservation components.

FIG. 2 is a detailed diagram of the Certificate-Guided Optimization Control System showing the Certificate Translator, Transformation Guardian, and constraint attachment to MLIR operations.

FIG. 3 is a diagram of the Dual-Plane Verification Architecture illustrating the Verification Plane, Optimization Plane, and the formal protocol governing their coordination.

FIG. 4 is a diagram of the Proof Certificate Translation and Preservation mechanism showing certificate extraction, normalization, progressive lowering, and cryptographic digest embedding.

FIG. 5 is a diagram of the Witness Architecture showing category-selective semantic graph traversal, witness registration, and structured MLIR certificate emission.

FIG. 6 is a diagram of the Coeffect Pipeline showing pre-computed verification properties flowing through SSA assignment, mutability analysis, escape analysis, and platform binding resolution.

FIG. 7 is a diagram of the three novel MLIR ecosystem extensions: Certificate Dialect, Verification Pass Manager, and Formal Verification Integration layer.

FIG. 8 is a diagram of the multi-target compilation flow showing verification preservation across CPU, FPGA, NPU, and MCU back-ends with target-gated witness registration.

### DETAILED DESCRIPTION OF THE INVENTION

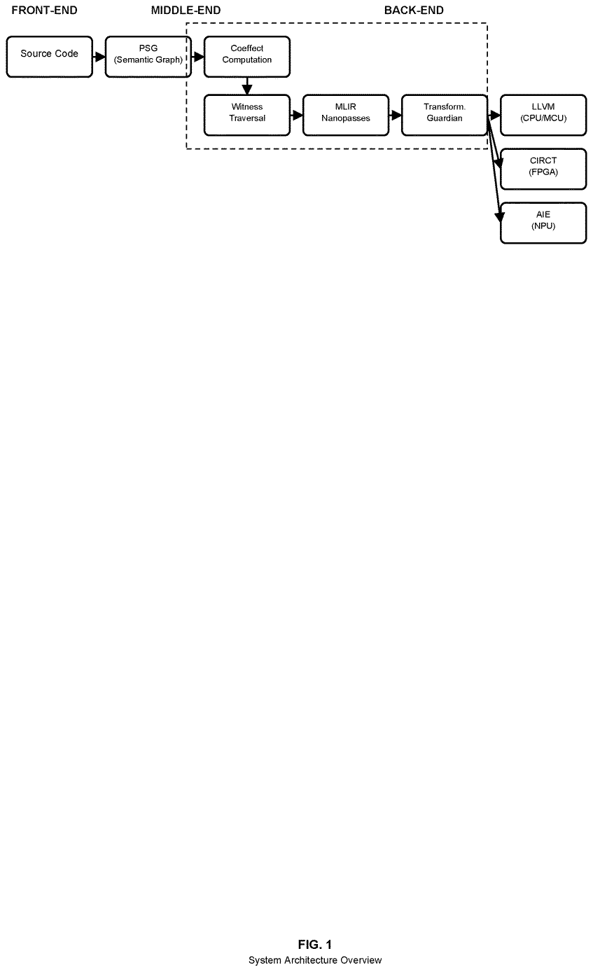

### 1. System Architecture Overview (FIG. 1)

The verification-preserving compilation system comprises a multi-stage pipeline organized into three principal phases: a front-end phase that receives source code with formal verification properties and produces a typed semantic graph; a middle-end phase that transforms the semantic graph into an optimized multi-level intermediate representation while preserving verification constraints; and a back-end phase that lowers the intermediate representation to target-specific machine code with embedded verification evidence.

The front-end phase receives source programs written in a language supporting formal verification annotations, including dimensional type annotations, algebraic grade constraints, escape classifications, and general functional correctness properties. The front-end performs type checking, semantic analysis, and AST saturation, producing a Program Semantic Graph (PSG) that encodes the complete semantic structure of the source program. The PSG retains all verification-relevant information as navigable node attributes and edge annotations.

The middle-end phase comprises two sub-phases executing in sequence. The first sub-phase, designated the Coeffect Computation phase, analyzes the PSG to pre-compute a set of immutable verification properties called coeffects. These coeffects include SSA (Static Single Assignment) value pre-assignment, mutability classification, escape analysis results, platform binding resolution, pattern binding decomposition, string literal pooling, curry flattening analysis, and target-specific properties such as FPGA bitwidth inference and pin mapping. The coeffects are computed once and remain immutable throughout subsequent compilation stages, serving as the formal verification context for all downstream decisions.

The second middle-end sub-phase, designated the Witness Traversal phase, performs a single post-order traversal of the PSG in which category-selective observers called witnesses examine semantic nodes matching their category and emit structured MLIR operations that encode both the computational semantics and the verification properties of each node. The emitted MLIR operations constitute verification certificates: each operation is formally constructed with type annotations, constraint attributes, and scope placement that collectively preserve the verification properties established by the front-end.

Following witness traversal, the generated MLIR module passes through a sequence of MLIR-to-MLIR optimization nanopasses. Each nanopass performs a single well-defined transformation. The Transformation Guardian component intercepts each proposed transformation and evaluates it against the constraint attributes attached to the operations being transformed. Transformations that preserve all attached constraints proceed; those that would violate constraints are rejected or modified to maintain constraint satisfaction.

The back-end phase receives the optimized MLIR module and lowers it to target-specific code through platform-selected lowering pipelines. For CPU and MCU targets, the system lowers through LLVM IR to native machine code. For FPGA targets, the system lowers through the CIRCT dialect framework to Verilog HDL with constraint files. For NPU (Neural Processing Unit) targets, the system lowers through the AIE dialect to accelerator-specific instructions. At each lowering stage, verification constraints are translated to the target representation, and a closed-loop artifact verification step confirms consistency between generated artifacts.

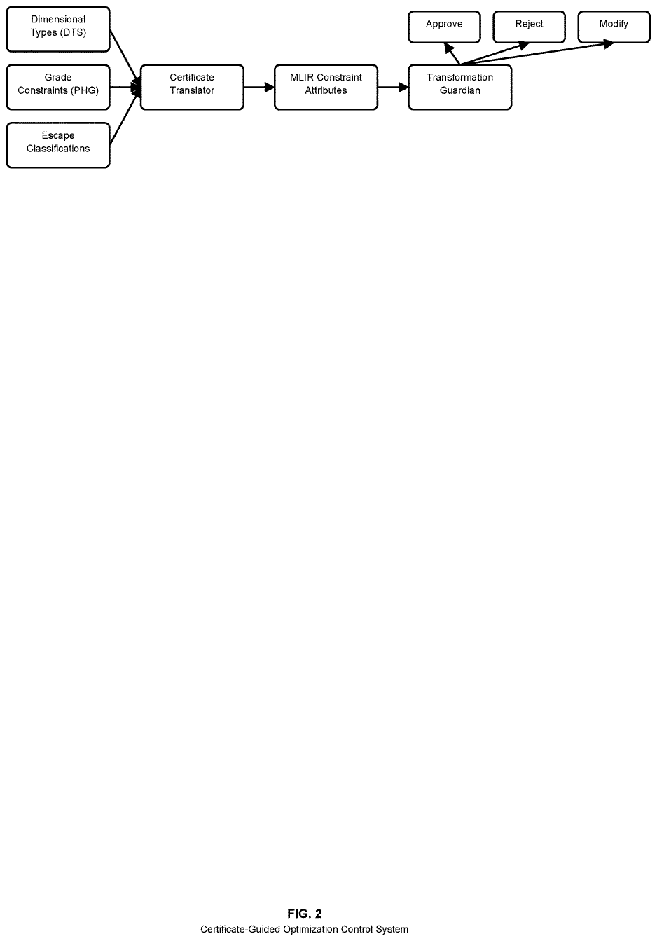

### 2. Certificate-Guided Optimization Control System (FIG. 2)

The Certificate-Guided Optimization Control System operates by translating formal verification certificates into compiler-internal constraint representations that are attached directly to MLIR operations. This translation creates a bidirectional bridge between verification systems and the compiler infrastructure.

The Certificate Translator component receives verification certificates from multiple sources. Dimensional type annotations are received as exponent vectors over the abelian group Z\hat{ }n, where each component represents an SI base dimension (length, mass, time, current, temperature, amount, luminous intensity) plus a Clifford algebra grade component. These dimensional constraints are verified by Gaussian elimination over Z in polynomial time O(n\hat{ }3), producing decidable yes/no answers for constraint satisfaction. The Certificate Translator normalizes these constraints into a canonical form and attaches them as MLIR attributes to the operations whose values carry dimensional annotations.

Escape classification certificates are received as lattice elements from the set {StackScoped, ClosureCaptured, ReturnEscaping, ByRefEscaping}, computed during coeffect analysis by propagating escape information through the semantic graph. The Certificate Translator attaches these classifications as MLIR attributes to memory allocation and access operations, constraining the set of valid allocation strategies for each value. A StackScoped classification, for example, constrains the allocator to use stack allocation and prevents any transformation that would promote the value to heap allocation.

Algebraic grade constraints from Clifford algebra computations are received as grade annotations derived from the geometric product structure of the source program. For a Clifford algebra Cl(p,q) with signature (p,q), the grade of a product c=a*b is constrained to the set {|grade(a)−grade(b)|, |grade(a)−grade(b)|+2, . . . , grade(a)+grade(b)}. These constraints are attached as MLIR attributes to arithmetic operations, preventing any optimization that would alter the grade structure of computed values.

The Transformation Guardian component intercepts all proposed optimization transformations before they are applied to the MLIR module. For each proposed transformation, the Guardian extracts the constraint attributes from all operations in the transformation's scope, evaluates whether the proposed transformation preserves all constraints, and renders a decision: approve (transformation preserves all constraints), reject (transformation would violate at least one constraint), or modify (transformation can proceed with specific adjustments to maintain constraint satisfaction). The Guardian operates as a synchronous interceptor within the optimization pipeline, adding negligible overhead because constraint evaluation involves comparison of pre-computed attributes and does not require re-running verification proofs.

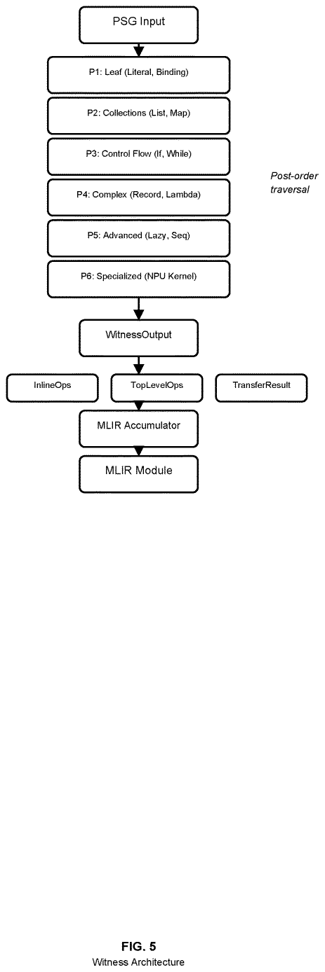

### 3. Witness Architecture for Certificate Generation (FIG. 5)

The compilation system employs a witness architecture for generating verification certificates during the PSG-to-MLIR translation phase. A witness is defined as a category-selective PSG traversal observer that examines semantic nodes of a specific kind and emits structured MLIR operations encoding the verification properties of those nodes.

Witnesses are organized into a priority-ordered registry. The preferred embodiment registers witnesses at six priority levels: Priority 1 (leaf witnesses) handles literal values, type annotations, structural nodes, and variable bindings. Priority 2 (collection witnesses) handles optional values, lists, maps, and sets. Priority 3 (control flow witnesses) handles conditional branching, pattern matching, and loop constructs. Priority 4 (complex witnesses) handles records, mutable memory operations, discriminated union types, lambda expressions, and hardware module definitions. Priority 5 (advanced witnesses) handles lazy evaluation and sequence generation. Priority 6 (specialized witnesses) handles target-specific constructs such as NPU kernel modules.

The witness registry implements target-gated registration: witnesses are conditionally registered based on the compilation target platform. For CPU and MCU targets, mutable assignment witnesses and memory intrinsic witnesses are registered while hardware module witnesses are excluded. For FPGA targets, hardware module witnesses are registered while mutable assignment witnesses are excluded. For NPU targets, kernel module witnesses are registered. This target-gating ensures that only semantically applicable witnesses participate in code generation, preventing the emission of operations that are invalid for the target platform.

All registered witnesses execute in a single post-order traversal of the PSG. Children are witnessed before their parents, ensuring that SSA bindings for sub-expressions are available when parent nodes are witnessed. Each witness examines the current node and returns a WitnessOutput comprising: a list of inline MLIR operations to be placed in the current scope; a list of top-level MLIR operations to be placed at module scope; and a transfer result that is either a typed SSA value, a void result, an error diagnostic, or a skip indication signaling that the witness does not handle this node category.

Witness coordination is managed through a shared accumulator that tracks emitted operations, SSA-to-type bindings, and module-level declarations. The accumulator implements dependent transparency coordination: when multiple witnesses attempt to emit the same module-level declaration (such as a global string constant or a closure thunk function), the accumulator ensures that only the first emission produces the declaration while subsequent emissions receive a reference to the existing declaration. This coordination prevents duplicate declarations without requiring inter-witness communication.

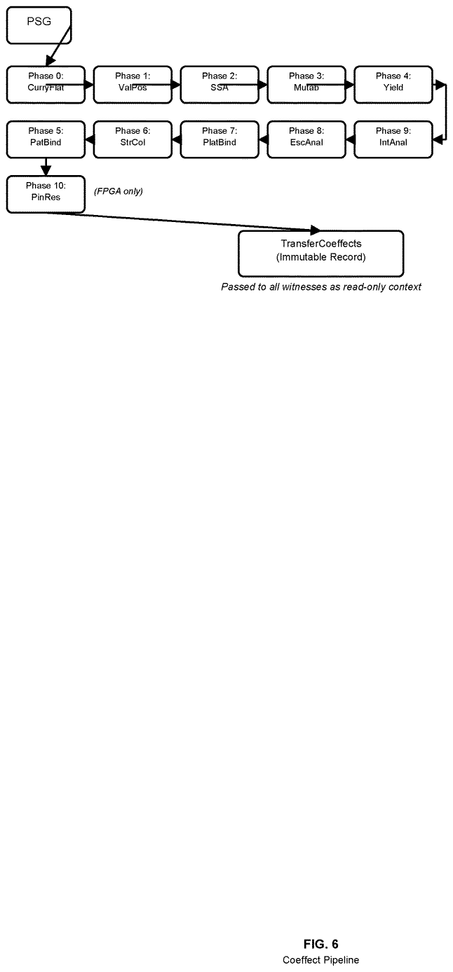

### 4. Coeffect Pipeline for Pre-Computed Verification Properties (FIG. 6)

The coeffect pipeline computes a comprehensive set of verification-relevant properties from the PSG before witness traversal begins. These properties are computed once, stored in an immutable record, and passed to all witnesses as read-only context. The immutability of coeffects ensures that verification properties cannot be inadvertently modified during code generation.

The coeffect pipeline executes the following analyses in sequence. Phase 0: Curry Flattening identifies curried function applications that can be flattened to direct calls with multiple arguments, recording the flattened arity and argument types. Phase 1: Value Position Analysis determines for each variable reference whether it refers to a local binding, a closure-captured variable, or a module-level declaration, constraining how the reference must be compiled. Phase 2: SSA Assignment pre-computes the number of SSA values each PSG node will produce during witness traversal, pre-allocating SSA identifiers to prevent allocation conflicts. Phase 3: Mutability Analysis classifies each binding as mutable or immutable, constraining memory operations to use load/store pairs for mutable bindings and direct value references for immutable bindings. Phase 4: Yield State Indices assigns state machine indices to generator yield points for async/iterator compilation. Phase 5: Pattern Binding Analysis decomposes pattern match expressions into binding sequences. Phase 6: String Collection pools string literal content for module-level global declaration. Phase 7: Platform Binding Resolution resolves foreign function interface calls to platform-specific implementations. Phase 8: Escape Analysis classifies each allocated value into one of four escape categories (StackScoped, ClosureCaptured, ReturnEscaping, ByRefEscaping), determining the allocation strategy. Phase 9 (FPGA only): Interval Analysis computes bitwidth requirements for integer operations. Phase 10 (FPGA only): Platform Pin Resolution maps logical I/O signals to physical FPGA pin assignments.

Each coeffect analysis produces results that constrain downstream compilation decisions. SSA pre-assignment prevents witness collisions. Mutability classification constrains memory access patterns. Escape analysis constrains allocation strategies. Platform binding resolution constrains calling conventions. These constraints collectively form the verification context within which all subsequent compilation decisions must operate. Because the coeffects are immutable, any attempt to violate these constraints during optimization will be detected by the Transformation Guardian.

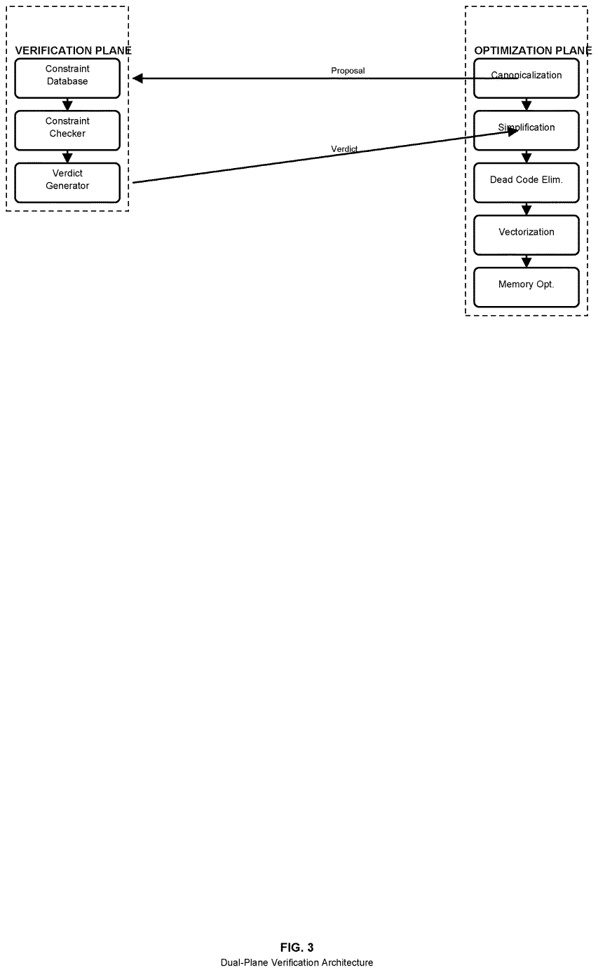

### 5. Dual-Plane Verification Architecture (FIG. 3)

The Dual-Plane Verification Architecture separates the compilation pipeline into two coordinated processing planes: a Verification Plane responsible for maintaining and checking formal constraints, and an Optimization Plane responsible for applying performance-enhancing transformations.

The Verification Plane maintains the current set of active constraints derived from the source program's verification properties. These constraints include dimensional consistency requirements, grade preservation requirements, escape classification invariants, type safety properties, and any user-specified functional correctness properties expressed as formal assertions. The Verification Plane does not directly transform code; it maintains the constraint database and responds to queries from the Optimization Plane.

The Optimization Plane executes the standard optimization pipeline: canonicalization, algebraic simplification, constant folding, dead code elimination, loop transformations, vectorization, and memory optimization. Before each optimization pass, the Optimization Plane queries the Verification Plane with the set of operations that the pass proposes to transform. The Verification Plane evaluates the proposed transformations against its constraint database and returns a constraint report indicating which transformations are safe, which would violate constraints, and which can proceed with modifications.

The coordination protocol between planes operates as follows. The Optimization Plane submits a transformation proposal comprising the operation identifiers, the proposed transformation type, and the expected result. The Verification Plane extracts the constraint attributes from the identified operations, evaluates the transformation against those constraints, and returns a verdict. If the verdict is approval, the Optimization Plane applies the transformation. If the verdict is rejection, the Optimization Plane skips the transformation and proceeds to the next candidate. If the verdict is conditional approval with modifications, the Optimization Plane applies the modified version of the transformation. This protocol ensures that every applied transformation has been verified against the formal constraint database.

The dual-plane architecture provides a separation of concerns that enables each plane to evolve independently. New optimization passes can be added to the Optimization Plane without modifying the Verification Plane, provided they submit transformation proposals through the standard protocol. New constraint types can be added to the Verification Plane without modifying the Optimization Plane, provided they are represented as standard MLIR attributes on operations.

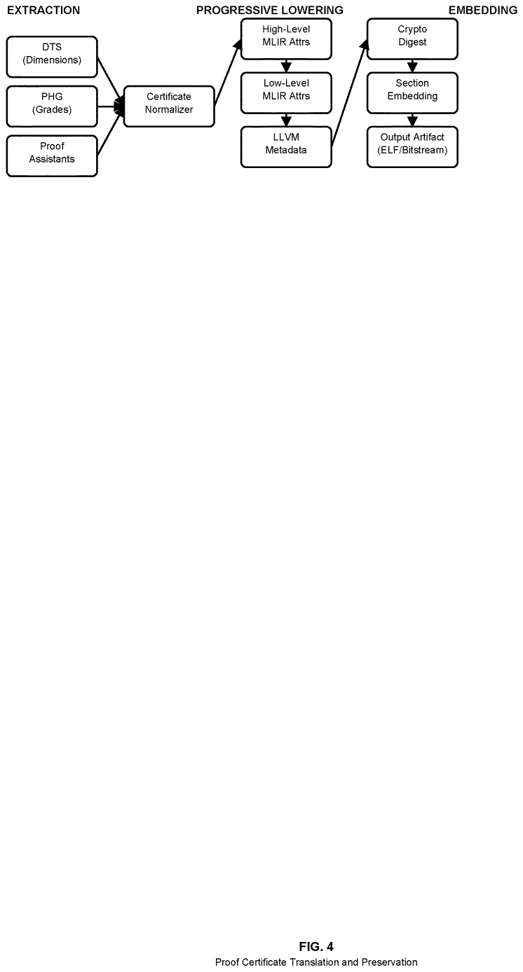

### 6. Proof Certificate Translation and Preservation (FIG. 4)

The Proof Certificate Translation and Preservation mechanism ensures that verification evidence survives the entire compilation pipeline from source language through intermediate representation to machine code. The mechanism operates in three stages: extraction, progressive lowering, and embedding.

During extraction, the system retrieves verification certificates from the source-level proof system. These certificates may originate from type-checking (dimensional type annotations verified by Gaussian elimination over abelian groups), from external proof assistants (correctness proofs exported as serialized proof terms), or from design-time verification (decidability proofs establishing that checked properties are complete and principal). The extraction stage normalizes all certificate formats into a canonical internal representation based on the Certificate Dialect's operation and attribute types.

During progressive lowering, the system translates certificates through each IR lowering stage. When MLIR operations are lowered from high-level dialects (such as the Certificate Dialect or the func dialect) to lower-level dialects (such as the LLVM dialect), the certificate attributes attached to those operations must be translated to equivalent representations in the target dialect. The system maintains a certificate translation table that maps high-level constraint representations to their low-level equivalents. For example, a dimensional consistency constraint expressed as an exponent vector attribute on an arithmetic operation is translated to a metadata node on the corresponding LLVM IR instruction. Escape classification constraints on memory operations are translated to LLVM alias analysis metadata that constrains the optimizer's treatment of those memory locations.

During embedding, the system generates cryptographic digests of the preserved certificates and embeds them in the final executable artifact. The digest computation takes as input the set of all active constraints that were satisfied during compilation, computes a hash tree over the constraint representations, and embeds the root digest in a designated section of the output artifact (an ELF section for native executables, a metadata block for FPGA bitstreams, or an annotation for NPU instruction streams). This embedded digest enables post-compilation verification: a consumer of the compiled artifact can independently recompute the constraint digests and compare them against the embedded values to confirm that the compilation preserved the claimed verification properties.

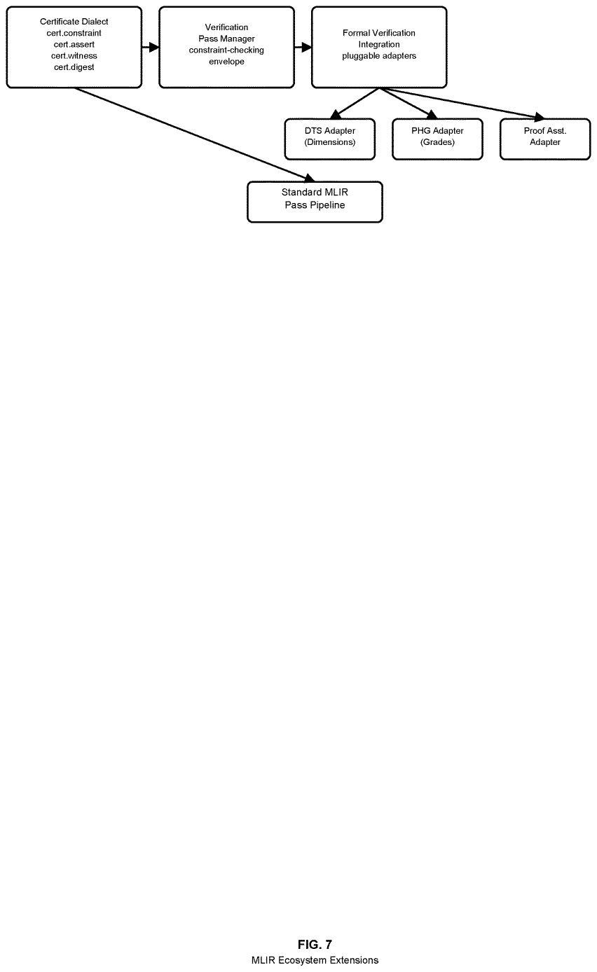

### 7. MLIR Ecosystem Extensions (FIG. 7)

The invention introduces three extensions to the MLIR compiler infrastructure that collectively enable verification-preserving compilation.

The Certificate Dialect defines a set of custom MLIR operations, types, and attributes for representing verification constraints within the compilation graph. Certificate operations include: cert.constraint, which attaches a formal constraint to a region of operations; cert.assert, which represents a verification assertion that must hold at a specific program point; cert.witness, which records the provenance of a verification decision (which witness emitted the enclosing operations and under which constraint context); and cert.digest, which holds a cryptographic hash of constraint data for post-compilation verification. Certificate types include a constraint type parameterized by the constraint domain (dimensional, escape, grade, or general) and an evidence type that wraps proof term references. Certificate attributes include constraint-value attributes that encode specific constraint values (such as dimensional exponent vectors or escape classifications) as compile-time constants.

The Verification Pass Manager extends the standard MLIR pass manager with constraint-aware scheduling. Before executing each optimization pass, the Verification Pass Manager queries the constraint database to determine which operations in the current module carry active constraints. It then wraps the optimization pass in a constraint-checking envelope that intercepts operation modifications and validates them against active constraints. If a modification would violate a constraint, the envelope prevents the modification and logs a diagnostic. The Verification Pass Manager also supports constraint-guided pass ordering: passes that are known to preserve specific constraint types can be scheduled before passes that might conflict with those constraints, reducing the number of rejected transformations.

The Formal Verification Integration layer provides a bridge between external proof systems and the compiler's internal constraint representation. The integration layer defines a protocol for receiving proof certificates from verification tools, translating them into Certificate Dialect attributes, and attaching them to the appropriate MLIR operations. The layer supports multiple proof systems through a pluggable adapter architecture: each supported proof system provides an adapter that translates its native certificate format to the canonical Certificate Dialect representation. The preferred embodiment includes adapters for dimensional type systems (translating exponent vectors from the DTS framework), for Clifford algebra grade verification (translating grade annotations from the PHG framework), and for general functional correctness properties (translating proof terms from dependently-typed proof assistants).

### 8. Coverage Validation and Completeness Checking

The compilation system includes a coverage validation mechanism that guarantees every reachable node in the PSG is witnessed by at least one witness during the traversal phase. After witness traversal completes, the coverage validator compares the set of visited nodes against the set of reachable nodes in the PSG. If any reachable node was not visited (meaning no witness produced MLIR operations for that node), the validator generates a diagnostic error identifying the unwitnessed node, its semantic category, its type, and its location in the source program.

Coverage validation serves as a completeness check for the verification-preserving compilation process. If a node is not witnessed, its verification properties are not translated into MLIR constraints, and the corresponding executable code would lack verification evidence. By failing compilation when coverage gaps are detected, the system ensures that the final artifact either carries complete verification evidence for all source-level properties or does not compile. There is no intermediate state in which some properties are preserved and others are silently dropped.

### 9. Formal Error Codes and Structured Diagnostics

The compilation system employs a structured diagnostic framework with formal error codes that categorize verification failures by subsystem. Error codes are organized into five series: AX1xxx for type resolution failures (such as unbound type variables or type mapping failures), AX2xxx for witness and traversal failures (such as missing SSA bindings or unresolved function references), AX3xxx for SSA and accumulator failures (such as SSA count mismatches), AX4xxx for pattern match emission failures, and AX5xxx for scope and control flow isolation failures.

Each diagnostic record comprises: a severity level (error, warning, or informational); an optional formal error code; an optional PSG node identifier locating the failure; a source identifier naming the witness or analysis that detected the failure; a phase identifier naming the specific pattern or transformation that failed; a human-readable message; and an optional pair of expected-versus-actual strings for mismatch diagnostics. This structured format enables automated error classification, reproducible failure identification, and systematic recovery strategies. When compilation fails due to a verification constraint violation, the diagnostic identifies the specific constraint, the specific operation, and the specific transformation that caused the violation.

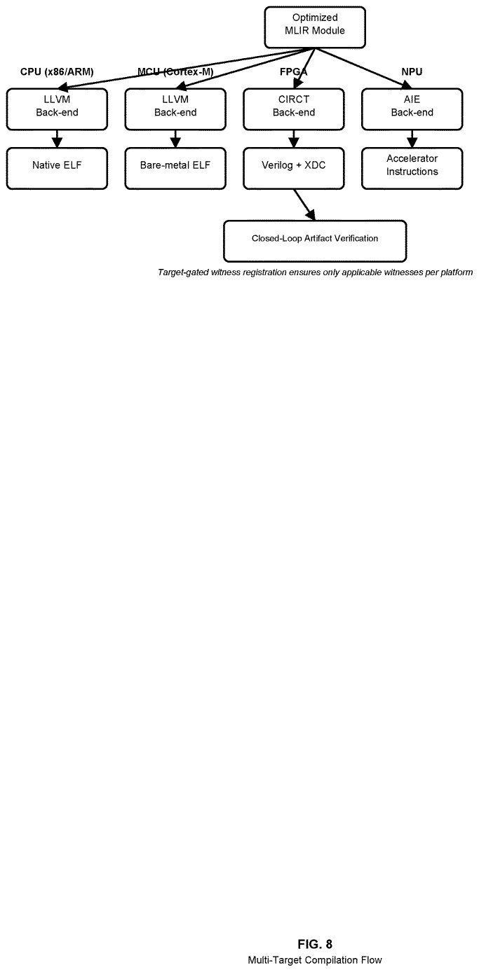

### 10. Multi-Target Compilation With Verification Preservation (FIG. 8)

The verification-preserving compilation system supports multiple compilation targets through a platform-aware pipeline that selects target-specific back-ends, witness registrations, and verification strategies based on the target platform designation.

For CPU targets (x86-64, ARM64, RISC-V), the system registers the full set of software-oriented witnesses (literal, binding, memory, lambda, control flow, mutable assignment, and memory intrinsic witnesses), computes software-oriented coeffects (escape analysis, curry flattening, platform binding resolution), and lowers through the LLVM back-end to native ELF executables. Verification constraints are translated to LLVM metadata during lowering.

For MCU targets (ARM Cortex-M), the system registers the same witness set as CPU targets but adjusts coeffects for the constrained environment: escape analysis favors stack allocation, platform bindings resolve to bare-metal HAL functions, and the deployment mode coefficient selects freestanding or embedded runtime semantics. Verification constraints related to memory safety are particularly important on MCU targets where memory protection hardware may be limited.

For FPGA targets, the system registers hardware-specific witnesses (hardware module witness) and excludes software-specific witnesses (mutable assignment witness). FPGA-specific coeffects include interval analysis for bitwidth inference and platform pin resolution for I/O assignment. The back-end lowers through the CIRCT dialect framework to SystemVerilog HDL and XDC constraint files. A closed-loop artifact verification step compares the ports declared in the generated HDL against the pins assigned in the constraint file, ensuring bidirectional consistency. Any port present in the constraint file but absent from the HDL, or vice versa, is flagged as a verification error.

For NPU targets, the system registers kernel module witnesses alongside standard witnesses. NPU-specific coeffects include tile mapping and data movement scheduling for spatial dataflow architectures. The back-end lowers through the AIE dialect to accelerator-specific instruction sequences. Verification constraints for NPU targets include co-location constraints (certain operations must execute on the same spatial tile) and data movement constraints (data transfers must respect memory hierarchy boundaries).

### 11. Execution Tracing for Verification Transparency

The compilation system provides an execution tracing mechanism that records the complete decision path for every witnessed node. Each trace entry records: the hierarchy depth (witness level, pattern level, or element level); the component name (which witness, pattern matcher, or builder produced the entry); the PSG node identifier; serialized parameters; and a sequential timestamp.

When compilation succeeds, the execution trace serves as an audit log documenting every verification decision made during compilation. When compilation fails, the trace reveals the exact sequence of witness invocations, pattern match attempts, and builder calls that led to the failure point. This transparency is critical for diagnosing verification failures in complex programs, where the interaction between multiple witnesses and constraint types can produce failures whose root cause is not immediately apparent from the final error diagnostic alone.

### 12. Recursive Witness Composition via Fixed-Point Combinator

The witness architecture supports recursive scope nesting through a fixed-point combinator pattern. Witnesses that handle scope-introducing constructs (lambda expressions, control flow blocks, hardware modules) must be able to invoke the full witness registry on nested sub-expressions. Because the registry includes the scope-introducing witness itself, this creates a recursive dependency.

The system resolves this recursion through lazy initialization of a combinator function. The registry constructs a lazily-evaluated combinator that, when forced, produces a function accepting a witness context and semantic node and returning a witness output. Scope-introducing witnesses receive a factory function that returns the combinator's current value when invoked. Because the combinator is lazily initialized, it captures the fully-constructed registry including all witnesses. This technique, derived from the Y-combinator pattern in lambda calculus, enables compositional witness nesting without stack overflow or infinite initialization loops.

This recursive composition capability is essential for verification preservation because verified programs routinely contain deeply nested scopes: lambda expressions within control flow blocks within function definitions within module declarations. Each nesting level must be witnessed with the full set of applicable witnesses, and verification constraints at each level must be independently maintained.

### 13. Integration With Dimensional Type Systems

The verification-preserving compilation system integrates with dimensional type systems that annotate values with physical dimension metadata. In the preferred embodiment, dimensions are represented as exponent vectors over the abelian group Z\hat{ }n, where n encompasses SI base dimensions plus an algebraic grade component. The dimensional type system provides three guarantees: decidability (constraint resolution produces definite yes/no answers in finite time), polynomial complexity (resolution cost is O(n\hat{ }3) via Gaussian elimination over Z), and principality (the most general solution exists and is unique).

Dimensional annotations persist through all compilation stages as PSG codata, MLIR attributes, and LLVM metadata. This persistence enables the compiler to make dimension-informed decisions at every stage. During representation selection, the compiler uses the dimensional range of a value to select the optimal numeric representation (IEEE 754 float, posit arithmetic, or fixed-point), because the dimensional range determines the required precision and dynamic range. During memory layout, the compiler uses dimensional compatibility to verify that values sharing memory regions are dimensionally consistent. During optimization, the Transformation Guardian uses dimensional constraints to prevent optimizations that would break dimensional invariants, such as reordering operations that would alter the dimensional interpretation of intermediate results.

What is claimed is:

1. A system for verification-preserving compilation, comprising:
a. a front-end module configured to receive source code having formal verification properties and to produce a program semantic graph encoding said verification properties as node attributes and edge annotations;
b. a coeffect computation module configured to analyze the program semantic graph and produce an immutable set of pre-computed verification properties including at least SSA value pre-assignment, escape classification, and mutability analysis;
c. a witness registry comprising a plurality of category-selective observers, each observer configured to examine semantic nodes of a specific category and to emit structured intermediate representation operations encoding verification properties of said nodes;
d. a certificate translator configured to translate verification certificates from formal proof systems into compiler-internal constraint representations attached as attributes to intermediate representation operations;
e. a transformation guardian configured to intercept proposed optimization transformations, evaluate each proposed transformation against constraint attributes attached to operations within the transformation scope, and selectively approve, reject, or modify each transformation based on constraint satisfaction; and
f. a back-end module configured to lower the intermediate representation to target-specific machine code while preserving constraint attributes through progressive lowering stages.

2. The system of claim 1, wherein the formal verification properties comprise dimensional type annotations represented as exponent vectors over an abelian group, the system further comprising a dimensional constraint solver performing Gaussian elimination over Z in polynomial time to verify dimensional consistency.

3. The system of claim 1, wherein the witness registry implements target-gated registration in which witnesses are conditionally registered based on a compilation target platform, such that only semantically applicable witnesses participate in code generation for each target.

4. The system of claim 1, further comprising a coverage validation module configured to compare the set of visited nodes against the set of reachable nodes in the program semantic graph and to generate a diagnostic error when any reachable node lacks a corresponding witness emission.

5. The system of claim 1, wherein the intermediate representation operations are defined within a multi-level intermediate representation framework supporting custom dialects, and wherein the system defines a certificate dialect comprising constraint operations, assertion operations, witness provenance operations, and cryptographic digest operations.

6. The system of claim 1, further comprising an accumulator module implementing dependent transparency coordination, wherein multiple witnesses attempting to emit identical module-level declarations are coordinated such that only a first emission produces the declaration and subsequent emissions receive a reference to the existing declaration.

7. The system of claim 1, wherein the escape classification comprises a lattice of at least four categories including stack-scoped, closure-captured, return-escaping, and by-reference-escaping, and wherein the transformation guardian prevents any optimization that would promote a stack-scoped value to a heap allocation.

8. The system of claim 1, further comprising a proof certificate embedding module configured to compute a cryptographic digest of preserved verification constraints and to embed said digest in a designated section of the output executable artifact.

9. The system of claim 1, wherein the back-end module supports a plurality of target platforms including at least two of: CPU native code, FPGA hardware description language, MCU bare-metal executable, and NPU accelerator instructions, with target-specific constraint translation at each lowering stage.

10. The system of claim 1, further comprising a closed-loop artifact verification module for FPGA targets, configured to parse generated hardware description language and constraint files and to verify bidirectional port consistency between them.

11. A method for preserving formal verification properties during compilation, comprising:
a. receiving source code annotated with formal verification properties;
b. constructing a program semantic graph from the source code, wherein the graph encodes verification properties as node attributes;
c. computing an immutable set of coeffect properties from the semantic graph, the coeffect properties comprising at least escape classifications, mutability classifications, and SSA value assignments;
d. traversing the semantic graph in post-order with a plurality of category-selective witnesses, each witness emitting structured intermediate representation operations that encode verification properties of observed nodes;
e. translating verification certificates into constraint attributes attached to the emitted intermediate representation operations;
f. evaluating each proposed optimization transformation against the constraint attributes and permitting only transformations that satisfy all applicable constraints; and
g. lowering the constrained intermediate representation to target-specific machine code while translating constraint attributes through each lowering stage.

12. The method of claim 11, further comprising validating witness coverage by comparing visited nodes to reachable nodes and failing compilation when any reachable node lacks a corresponding witness emission.

13. The method of claim 11, wherein traversing with category-selective witnesses comprises executing all witnesses in a single traversal pass, with witness coordination managed through a shared accumulator implementing dependent transparency to prevent duplicate module-level declarations.

14. The method of claim 11, wherein computing coeffect properties further comprises performing escape analysis that classifies each allocated value into one of a plurality of escape categories, and wherein the escape classification constrains subsequent allocation strategy selection.

15. The method of claim 11, further comprising embedding a cryptographic digest of preserved verification constraints in the output artifact, enabling post-compilation verification that the claimed properties were preserved.

16. The method of claim 11, wherein evaluating proposed transformations comprises a dual-plane architecture in which a verification plane maintains a constraint database and an optimization plane submits transformation proposals through a synchronous protocol.

17. The method of claim 11, wherein the formal verification properties comprise at least one of: dimensional type annotations over abelian groups, Clifford algebra grade constraints, and functional correctness assertions from proof assistants.

18. A non-transitory computer-readable medium storing instructions that, when executed by a processor, cause the processor to:
a. construct a program semantic graph from source code having formal verification annotations, wherein verification properties are encoded as graph node attributes;
b. pre-compute an immutable coeffect record from the semantic graph, the coeffect record comprising escape classifications, mutability classifications, SSA assignments, and platform binding resolutions;
c. execute a witness traversal of the semantic graph using a registry of category-selective witnesses that emit typed intermediate representation operations preserving verification properties;
d. attach constraint attributes derived from verification certificates to the emitted operations;
e. intercept each proposed optimization transformation and evaluate it against attached constraint attributes, permitting only constraint-satisfying transformations; and
f. generate target-specific machine code with embedded cryptographic verification digests.

19. The non-transitory computer-readable medium of claim 18, wherein the instructions further cause the processor to conditionally register witnesses based on the target platform, excluding witnesses that are not semantically applicable to the selected compilation target.

20. The non-transitory computer-readable medium of claim 18, wherein the instructions further cause the processor to resolve recursive scope nesting through a lazy fixed-point combinator that enables scope-introducing witnesses to invoke the full witness registry on nested sub-expressions.
